(19) United States
(12) Patent Application Publication
(10) Pub. No.: US 2025/0081024 A1
(43) Pub. Date: Mar. 6, 2025

(54) CONTROL WITHIN WIRELINE-WIRELESS PHYSICALLY CONVERGED ARCHITECTURES

(71) Applicant: PHYTunes, Inc., Palo Alto, CA (US)

(72) Inventors: Vinay Joseph, KERALA (IN); Akula Aneesh Reddy, San Jose, CA (US); Jisung Oh, Palo Alto, CA (US)

(73) Assignee: PHYTunes, Inc., Palo Alto, CA (US)

(21) Appl. No.: 18/242,942

(22) Filed: Sep. 6, 2023

(51) Int. Cl. H04W 28/02; H04W 28/08

(52) U.S. Cl. CPC H04W 28/0236; H04W 28/0967

(57) ABSTRACT

Embodiments of the present invention provide systems, devices and methods for generating, analyzing, transmitting and utilizing control information within a wireline-wireless architecture. In certain examples, control information is transmitted between intermediate nodes, distribution nodes and wireless remote device to adjust at least one parameter to improve performance.

### BACKGROUND

### A. Technical Field

The present invention relates generally to telecommunication systems, and more particularly, to wireline-wireless physically converged communication architectures that may deploy dynamic generation, transmission, reception, processing and utilization of control information across one or more segments within the architectures.

### B. Background of the Invention

One skilled in the art understands the importance of wireless communication systems (including LTE, 5G, and Wi-Fi architectures) and the complexity of these systems as they are constructed and maintained around the world. As the complexity of these systems increases and the resources available to them are allocated across an increasingly higher frequency spectrum, the management of wireless channels becomes more challenging. For example, a cellular base station or Wi-Fi access point must manage many channels in communicating with a remote device (such as a User Equipment [“UE”] within a cell or a remote device within a Wi-Fi Local Area Network [“LAN”]) while the characteristics of these channels are constantly changing. This management of channels becomes more challenging in dense cities in which wireless signals must traverse a variety of physical barriers and address complex interference patterns to reach a UE such as a cellphone. This channel quality and range issue is particularly problematic when channel frequencies increase and are more sensitive to interference, noise, varying channel properties and obstacle density.

Cellular subscriber lines (hereinafter, “CSL”) employ the novel concept of using the existing wireline infrastructure (e.g., telephone lines, fiber-optic cables, Ethernet wires, coaxial cables) in conjunction with a wireless infrastructure to extend the coverage of cellular or Wi-Fi signals quickly, inexpensively, and securely within a building.

The architecture of the cloud-based CSL networks implements a unit at each of the two ends of the wireline connection: the CSL-intermediate-frequency (“CSL-IF”) unit IF-modulates a wireless or wireline downlink baseband signal and transmits the modulated signal to a CSL-radio-frequency (“CSL-RF”) unit at the other end of the wireline. The CSL-RF unit up-converts the signal for downlink wireless transmission to nearby client devices, such as IoT devices and smartphones. In certain examples, the CSL-IF unit is interfaced with a baseband unit located at a cell-tower or at a central office of the CSP. In other examples, the CSL-IF unit is interfaced with a Wi-Fi signal source that may be located in a variety of different wireless/wireline equipment. For downlink, the CSL-IF unit generates baseband digital streams from the BBU output/Wi-Fi equipment. For uplink, the CSL-RF unit receives wireless signals from nearby client devices, intermediate-frequency modulates the signals, and transmits the modulated signal to the CSL-IF unit at the other end of the wireline. The CSL-IF unit converts the baseband digital streams to specific O-RAN split signals for the BBU input/Wi-Fi equipment.

The wireline medium connecting the CSL-IF and CSL-RF units impacts CSL's performance. The wire is used as a transmission medium for IF-modulated downlink baseband signals to the CSL-RF unit. The CSL-RF unit may implement beamforming techniques to focus a downlink wireless signal toward a recipient UE. This beamforming results in interference reduction within the cell/Wi-Fi LAN (i.e., the CSL-RF unit service area) and improves power characteristics by focusing transmission power to the UE/remote device. The wire is used as a transmission medium for IF-modulated uplink baseband signals to the CSL-IF unit. One skilled in the art will recognize that the transmission characteristics of the wireline segments and the wireless segments of the CSL architecture may meaningfully vary.

Within this CSL architecture, managing signals across the various segments is a challenge. Channel characteristics may vary across these different segments which changes the manner in which signals propagate across these segments. For example, interference and signal degradation occur within wireline and wireless transmission as a signal propagates through a wireline-wireless connection and may affect a variety of performance parameters including segment bandwidth. Accordingly, the performance of one segment may adversely affect the performance of other segments within this architecture and may reduce the performance of the overall system.

Accordingly, what is needed are systems, devices and methods that address the above-described issues.

### SUMMARY OF THE INVENTION

Embodiments disclosed herein are systems, devices, and methods that can be used to provide improved performance (e.g., bandwidth, data rate, quality of service, coverage, etc.) on wireline-wireless connectivity by generating, analyzing and transmitting control information across the wireline-wireless architecture. In certain embodiments, channel properties across different segments are measured and transmitted to nodes within the architecture. Control information, which includes these measured channel properties, are gathered, generated, analyzed and transmitted through different segments to manage transmission of data within the architecture. Control information may additionally include configuration information for the nodes within the architecture, which may in certain cases may be determined based on channel properties of the different segments. For example, control information may be constructed based on measured channel properties and inserted within packet preambles and postambles for subsequent analysis and management of one or more segments, or one or more nodes within the architecture. In other examples, control information may be communicated as standalone packets. This control information may be multiplexed within channels that also communicate data and/or communicated in channels dedicated to transmission of the control information, such as those within a control plane. This control information may be used to coordinate between wireline transmission and associated wireless signal generation, scheduling and reception to improve performance across a wireline or wireless connection within the architecture.

Configuration information conveys information about how to configure a particular node within the architecture. For instance, an intermediate node may obtain wireline channel information (e.g., attenuation) for a wireline segment to a particular distribution node using measurements of the wireline segment, and then select a preamble (from a predefined set of preambles or preamble length) which is suited for the obtained wireline channel information. When sending configuration information to the distributed node, the intermediate node may just indicate the ID of selected preamble (i.e., configuration information for the distribution node) without sending related channel information.

In certain embodiments, first control information (such as measured channel parameters or configuration parameters) are received at an intermediate node or distribution node, the first control information is analyzed and used in part to generate second control information that is subsequently transmitted within the wireline-wireless architecture. The structure and properties of the second control information may vary across different implementations of embodiments of the invention. Adjustments to the manner in which data is transmitted through the wireline-wireless architecture may occur in response to one or more of the first control information or the second control information. This second control information may be transmitted during an initialization process or during operation of the architecture.

It is important to note that, in the context of various embodiments of the invention, the term “base station” includes both base station installations that incorporate a cell tower as well as base station installations that do not include a cell tower.

In this document, the disclosures are presented in the context of, but are not limited to applications that use, the cellular subscriber line (CSL) framework. Concepts related to the CSL framework are described in “Wireless-wireline physically converged architectures,” U.S. Patent Publication No. 2021/0099277 A1; and J. M. Cioffi et al., “Wireless-wireline physically converged architectures,” WIPO Patent Publication No. WO2021/062311, both of which are hereby incorporated by reference in their entireties. CSL systems use the existing wireline infrastructure (e.g., telephone lines, fiber-optic cables, Ethernet wires, coaxial cables, etc.) in conjunction with the wireless infrastructure to extend the coverage of wireless signals quickly, inexpensively, and securely. CSL systems can include hardware and/or software components to transmit and/or process signals at a variety of frequencies, including RF and IF. CSL systems are one example of wireline-wireless architectures.

Certain features and advantages of the present invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a wireline-wireless cloud-based architecture that includes intermediate and distribution nodes coupled to each other by a wireline cable (e.g., twisted pair, coaxial cable, etc.) in accordance with various embodiments of the invention.

FIG. 2 is an exemplary diagram of a cellular wireline-wireless architecture comprising at least one wireline segment and at least one wireless segment in accordance with various embodiments of the invention.

FIG. 3 illustrates an example of a packetization technique for use within a wireline segment according to various embodiments of the invention.

FIG. 4 illustrates another aspect of an example of a packetization within a wireline segment according to various embodiments of the invention.

FIG. 5 illustrates an exemplary intermediate node and communication flow according to various embodiments of the invention.

FIG. 6 illustrates different interleaving packet techniques used to generate multi-stream signals according to various embodiments of the invention.

FIG. 7 illustrates an exemplary downlink intermediate node architecture in which a single path is employed to generate a multi-stream downlink signal in accordance with various embodiments of the invention.

FIG. 8 illustrates an exemplary downlink intermediate node architecture in which multiple paths are employed to generate a multi-stream downlink signal in accordance with various embodiments of the invention.

FIG. 9 illustrates an exemplary uplink intermediate node architecture in which a single path is employed to demultiplex a multi-stream uplink signal in accordance with various embodiments of the invention.

FIG. 10 illustrates an exemplary uplink intermediate node architecture in which multiple paths are employed to demultiplex a multi-stream uplink signal in accordance with various embodiments of the invention.

FIG. 11 illustrates an exemplary distribution node and communication flow according to various embodiments of the invention.

FIG. 12 illustrates two wireline segments within a wireline-wireless architecture according to various embodiments of the invention.

FIG. 13 illustrates two wireline segments on which uplink control information is transmitted to a first distribution node and a second distribution node according to various embodiments of the invention.

FIG. 14 illustrates two wireline segments on which downlink control information is transmitted to an intermediate node according to various embodiments of the invention.

FIG. 15 illustrates an intermediate node that receives first control information and generates second control information according to various embodiments of the invention.

FIG. 16 illustrates a distribution node that receives first control information and generates second control information according to various embodiments of the invention.

FIG. 17 illustrates different packet formats in which data and control information are packetized according to various embodiments of the invention.

FIG. 18 illustrates time delay on uplink and downlink transmissions from an intermediate node, a distribution node and a wireless device according to various embodiments of the invention.

### DETAILED DESCRIPTION OF THE PREFERRED EMBODIMENTS

Embodiments of the present invention provide systems, devices and methods for managing the transmission of one or more streams from cellular equipment (e.g., BBU, base station, etc.) and/or Wi-Fi equipment on at least one of a wireline segment and/or wireless segment within a wireline-wireless architecture. In certain examples, streams are packetized in accordance with a preferred packetization process and combined into a multi-stream signal that is subsequently transmitted on a wireline segment. The multi-stream signal is supplemented with control information that allows intermediate and distribution nodes to adjust parameters to improve overall performance of the network. The one or more streams and control information are received from the wireline segment, demultiplexed and processed to generate a plurality of wireless signals corresponding to the plurality of streams. The plurality of wireless signals is transmitted to intended recipients which may include user equipment within a cell, remote terminals within a Wi-Fi LAN, or any other type of device capable of receiving a wireless signal.

In certain examples, the architecture leverages pre-existing wireline connectivity within a building to allow a signal to traverse physical barriers, such as walls, on the wireline segment(s) while using wireless portions of the channel to communicate signals in air both outside and inside the building. The properties of the wireline segment(s) will affect the manner in which the signal propagates including bandwidth and attenuation constraints. Determination of how a multi-stream wireline signal is constructed may depend on a number of different variables including properties of the wireline and/or wireless segments. The multi-stream signal may be constructed using a variety of different interleaving techniques, including those described below, which are not intended to be limiting.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. The embodiments of the present invention may function in various different types of environments wherein channel sensitivity and range are adversely affected by physical barriers within the signal path. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

The term “intermediate node” denotes a device that couples a BBU to a wireline segment and facilitates measurement of parameters on the wireline segment and transmits wireline signals to one or more distribution nodes. The CSL-IF unit is one example of an intermediate node. The term “distribution node” denotes a device that couples a wireline segment to a wireless segment and that has a configurable MIMO antenna used to transmit and/or receive wireless signals from at least one device. The CSL-RF unit is one example of a distribution node. The terms “wireline segment” and “wireline connection” are used interchangeably and refer to any conductive wire that transmits a signal between two devices. The terms “wireless segment” and “wireless connection” are used interchangeably and refer to wireless connectivity that transmits a signal between to devices.

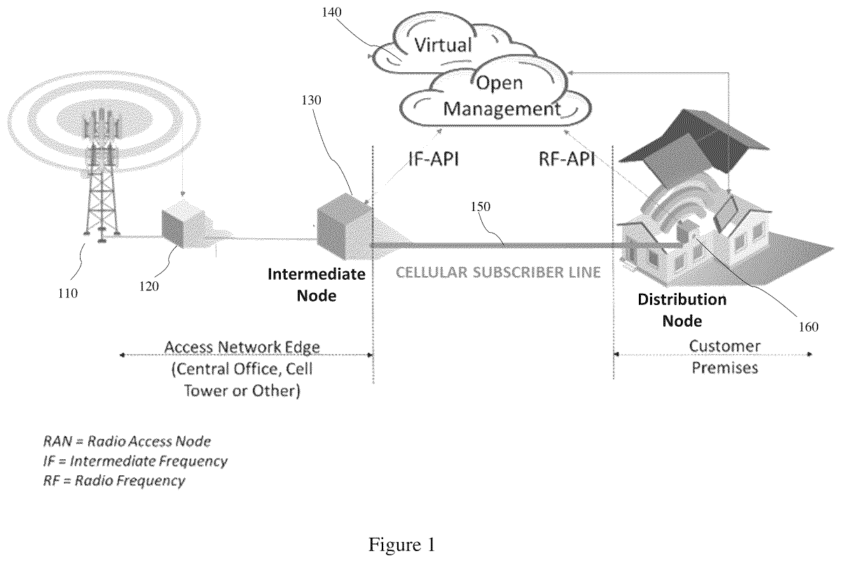

FIG. 1 illustrates a wireline-wireless cloud-based architecture that includes intermediate and distribution nodes coupled to each other by a wireline cable (e.g., twisted pair, coaxial cable, etc.) in accordance with various embodiments of the invention. The intermediate node 130 interfaces with a BBU 120 (which may include a base station 110) located, for example, at a cell-tower or at a central office of the cellular service provider (CSP). For purposes of this application the term “BBU” should be construed to cover a base station, central office, baseband unit or any other component operationally within a cell tower or cell tower system to transmit signals intended for user equipment and receive signals transmitted by the UE. The connection between the BBU 120 and the intermediate node 130 may be a wired connection according to various embodiments of the invention. In other embodiments, the connection between the BBU 120 and the intermediate node 130 may be wireless.

The intermediate node 130 receives one or more baseband digital streams from the BBU output (downlink direction) and converts the baseband digital streams to specific O-RAN split signals for the BBU input (uplink direction). As previously mentioned, these O-RAN signals may be communicated via a cable or wireless channel(s). In the downlink direction, the intermediate node 130 modulates the wireless baseband signal into intermediate frequency (IF) signal(s), and transmits the IF-modulated signal over the wireline cable 150 to a distribution node 160 at the other end of the wireline cable 150. The distribution node 160 up-converts the received signal to RF signals and transmits the RF signals to one or more UEs (e.g., IoT devices, smartphones, etc.). Similarly, in the uplink direction, the distribution node 160 receives RF signals from a UE, down-converts these signals to the IF, and transmits IF-modulated signals over the wireline cable 150 to the intermediate node 130.

The wireline cable 150 that couples the intermediate node 130 and distribution nodes 160 allows the intermediate node 130 to send IF-modulated baseband signals to the distribution node 160. The intermediate node 130 receives uplink samples from the distribution node 160, which had been down-converted by the distribution node 160 from the radio-frequency range to intermediate frequency. The wireline cable 150 has an impact on the performance of the wireline-wireless system and may require that multiple streams within the signal received from the BBU 120 to be combined into a single multi-stream signal for transmission on the wireline segment 150.

In certain embodiments, the wireline-wireless architecture may be managed or partially managed by a cloud-based system or server 140. For example, an IF-API and RF-API may provide connectivity to the cloud to enable remote management of system performance and integrity.

When using intermediate node 130 with MIMO over the wireless link, the intermediate node 130 may need to transmit downlink baseband inputs corresponding to multiple spatial streams to distribution node 160. Similarly, distribution node 160 may transmit signals corresponding to multiple spatial streams to the intermediate node 130. Thus, when using MIMO, more samples need to be sent over the wireline medium 150 over the same duration and thus this requires much higher wireline bandwidth. For transmitting multiple spatial streams, a single IF signal may be used or multiple intermediate frequency signals may also be used with one IF associated with a subset of spatial streams. As previously mentioned, one skilled in the art will recognize that a similar architecture may be employed to service multiple remote wireless devices in one or more Wi-Fi LANs.

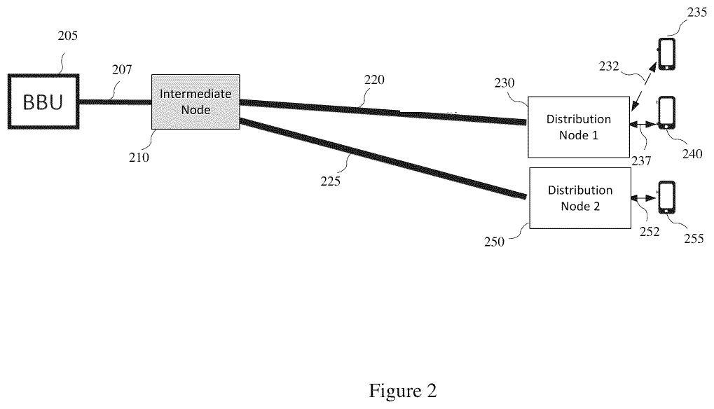

In some embodiments, a single intermediate node can be connected to a plurality of (i.e., two or more) distribution nodes in which some or all of the wireline segments transmit multi-stream signals as described below. FIG. 2 shows an example in which a single intermediate node 210 is coupled to a BBU 205 and coupled to two distribution nodes 230, 250. Specifically, the intermediate node 210 is coupled to distribution node 1 230 over a first wireline segment 220, and to distribution node 2 250 over a second wireline connection 225. In this example, a common baseband is transmitted between the BBU 205 and the intermediate node 210, but different signals are transmitted between the intermediate node 210 and the various distribution nodes 230, 250. In certain instances, the same signal may also be transmitted between an intermediate node and various distribution nodes coupled to it. The wireline connections between the intermediate node 210 and the various distribution nodes 230, 250 may multiplex streams across one or both of the wireline connections 220, 225.

In one instance, wireline connection 220 transmits a multi-stream signal in which a first stream intended for UE 235 and a second stream intended for UE 240 are multiplexed together. The first stream is wirelessly transmitted on channel 232 to UE 235 and a second stream is wirelessly transmitted on channel 237 to UE 240. In another instance, wireline connection 225 may transmit a single stream signal or multi-stream signal (e.g., multiple streams corresponding to different applications operating on the UE) to UE 255. This single or multiple streams is wirelessly transmitted on channel(s) 252 to UE 255.

One skilled in the art will recognize that the architecture and connectivity between the different devices are able to transmit both downlink and uplink. Time-division multiplexing or frequency division multiplexing may be deployed on each of the segments within the system.

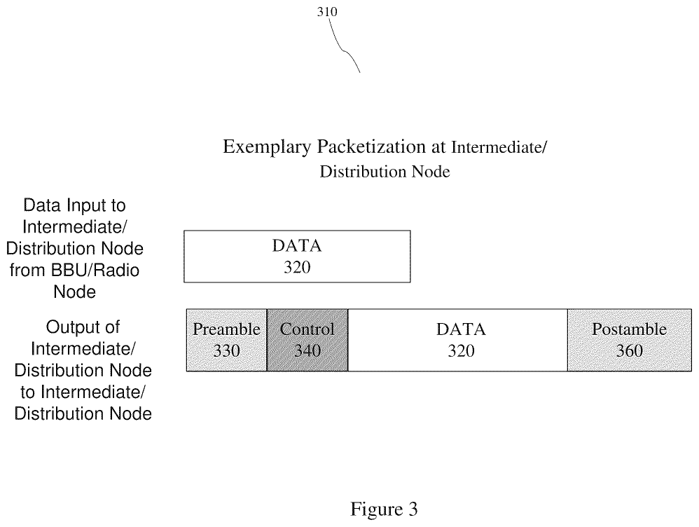

FIG. 3 illustrates an exemplary packetization structure 310 that may be employed in a wireline-wireless architecture according to various embodiments of the invention. One skilled in the art will recognize that other packetization structures may be employed that are consistent with and enabled by the description herein. As shown, data 320 is generated based on signals received from a BBU or other RF device such as Wi-Fi equipment. Packets generated by intermediate node (and sent to distribution node) comprise of wireline-wireless downlink data signal generated based on a subset of baseband downlink data received by intermediate node from BBU. If the data 320 is being transmitted on a downlink, an intermediate node packetizes the data 320 by generating control information 340 that is placed adjacent to the data 320 on its front end. In certain instances, modified data block may be obtained by modifying the data 320 using operations such as IFFT/FFT, upsampling/downsampling, filtering, up-conversion/down-conversion, etc. and may be used in place of data block 320 in a packet.

A preamble 330 is created and positioned adjacent to the control information and a postamble 360 is created and positioned adjacent to data 320 as shown in the illustration. The control information, preamble and postamble are used by a distribution node to process the packet and generate a wireless signal to be transmitted to a user equipment. In some embodiments, a) only a subset of preamble, control information and postamble is used (for example, it may be sufficient to add only a preamble in certain settings) b) a preamble, a control information and postamble could be associated with one or more data received from a BBU (for instance, we may only send one control information or one preamble for all symbols of a slot). The sequence of the control and data may be reversed in accordance with various embodiments of the invention.

If the data 320 is being transmitted on the uplink, then packetization occurs on a distribution node and transmitted to an intermediate node. The intermediate node processes the packet and generates a signal to be transmitted to a BBU. In certain embodiments, packets generated by the distribution node (and sent to the intermediate node) are based on a subset of uplink data received by the distribution node in which: (1) the subset may be a subset of resource blocks, (2) it may be determined based on wireline-wireless control information sent by the intermediate node to the distribution node, (3) which in turn may be determined using ORAN control signals received by the intermediate node.

In various embodiments, data 320 comprises one or more time-domain IFFT signals that include both wireless data and control. The control information 340 may include information related to distribution node ON/OFF status, statistics of the intermediate node, and TDD frame format (e.g., DDDUUDDDUU) of a wireless segment to name a few. One skilled in the art will recognize that other information may be included in the control information.

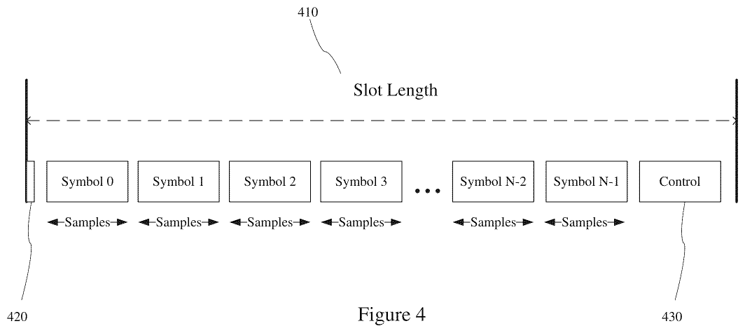

FIG. 4 illustrates a detailed packetization structure of a downlink packet according to various embodiments of the invention. As shown, a packet is shown within a predefined slot length 410 and may be used within a 5G deployment of the wireline-wireless architecture. A first set of symbols 420 represents the preamble and a second set of symbols 430 represents control information. The transmissions associated with N (indexed 0 to 13) symbols in a slot are separated by gaps (durations without any transmission). If this packetization structure is deployed in a 5G architecture with 4096 IFFT output samples per symbol and intermediate node performs 4× upsampling, then (1) N is equal to 14, (2) the first symbol (symbol 0) contains 17792 samples, (3) subsequent symbols (symbols 1-13) contain 17536 samples, and (4) the gaps between each of the symbols contains 500 samples. One skilled in the art will recognize that aspects of the packetization structure may be modified to support other configurations of 5G (e.g., other subcarrier choices, number of streams, lower bandwidth, etc.) and various standards including Wi-Fi standards.

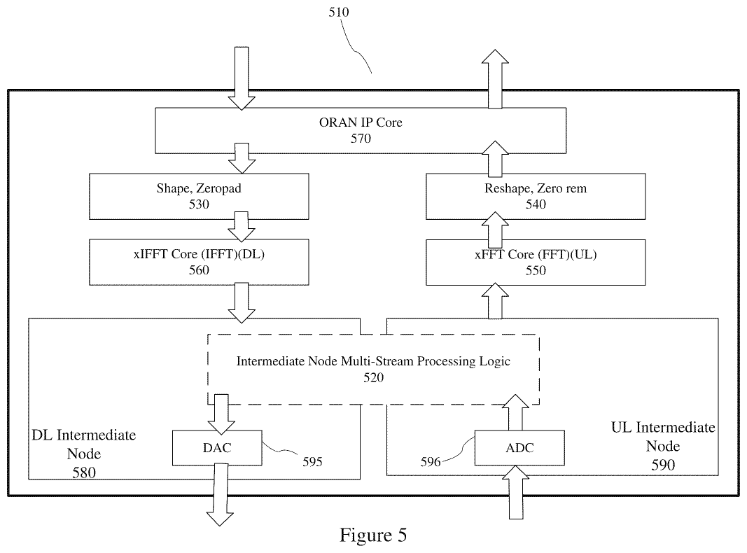

FIG. 5 illustrates an exemplary intermediate node showing uplink and downlink paths according to various embodiments of the invention. The intermediate node 510 comprises an ORAN IP core 570 that interfaces with and provide interoperation with cellular equipment such as BBUs. Various embodiments of the ORAN IP core 570 provides frequency domain operations on wireless baseband signals such as adding/removing guard subcarriers (at the edge of signals spectrum) and zero/low strength DC subcarriers (at very low frequencies). The ORAN IP core 570 may also process O-DU packets including the step of obtaining O-RAN control, synchronization and data information. Other functions may also be performed by the ORAN IP core 570 as understood by one of skill in the art.

Both the uplink and downlink paths also comprise multi-stream processing logic 520 that provides functionality to multiplex downlink streams into multi-stream signals and de-packetization of uplink multi-stream signals. As previously stated, interleaving multiple streams within a wireline signal allows the architecture to coordinate performance (such as bandwidth management) between wireline segments and wireless segments. The operation of this multi-stream processing logic 520 is described in more detail later in the application.

Referring to the downlink path, cellular (or other wireless types of signals such as Wi-Fi) signals are received at ORAN IP core 570. The ORAN processed signal is provided to a Shape and Zeropad logic 530 that performs (a) shaping (e.g., re-ordering of input samples) of spatial streams, and (b) addition of guard samples, zeros and DC subcarriers. The shaping of spatial streams is performed on samples received from the ORAN IP core 570 where a certain number of samples (which may correspond to a 5G sample/symbol/slot or a part thereof) for each stream are involved. In some embodiments, the shaping of spatial streams is used to convert the output of ORAN IP core 570 into a format suitable for xIFFT core 560. For instance, ORAN IP core 570 output may use a single output port for multiple streams whereas xIFFT core 560 may have one separate input port for each stream. This process may be realized in a variety of different ways including embodiments where multiple streams are shaped.

The shaped streams are provided to an xIFFT core 560 that performs functions that convert the streams from the frequency domain to time domain. Thereafter, each stream is transmitted to multi-stream processing logic 520 for processing in preparation to transmission on a wireline segment within the architecture. The multi-stream processing logic 520 is located within a downlink intermediate node path 580 and provides upsampling/interpolation, filtering and up-conversion to an intermediate frequency for transmission on the wireline, which may include setting center frequencies of the up-conversion based at least partially on frequencies used by other transmissions on the wireline medium and/or number of spatial streams. Thereafter, the signals are filtered and transmitted to a digital-to-analog converter 595.

Referring to the uplink path, wireline signals are received at an intermediate node uplink path 590 and converted to a digital signal by an analog-to-digital converter 596. The converted digital signal is received at the multi-stream processing logic where it is demultiplexed and processed to a plurality of streams, and this may involve operations such as down-conversion and filtering. This demultiplexing and related functions are described in more detail below. The demultiplexed streams are transmitted to an xFFT core 550 that converts the streams from the time domain to the frequency domain. In some embodiments, intermediate node uplink path 590 may perform additional functions such as PRACH filtering/extraction, SRS filtering/extraction etc.

The converted streams are transmitted to a reshape and zero removal logic 540 that reshapes the converted streams and removes any zeros that were added by the Zeropad operation. The reshape and zero rem logic 540 performs (a) reshaping (e.g., reordering) of spatial streams and control, and (b) operation involving removal of guard and DC subcarriers. In some embodiments, the reshaping is used to convert the output of xFFT core 550 into a format suitable for ORAN IP core 570.

The demultiplexed and processed streams are transmitted to the ORAN IP core 570 that further processes the streams to provide interoperability with the BBU at a base station.

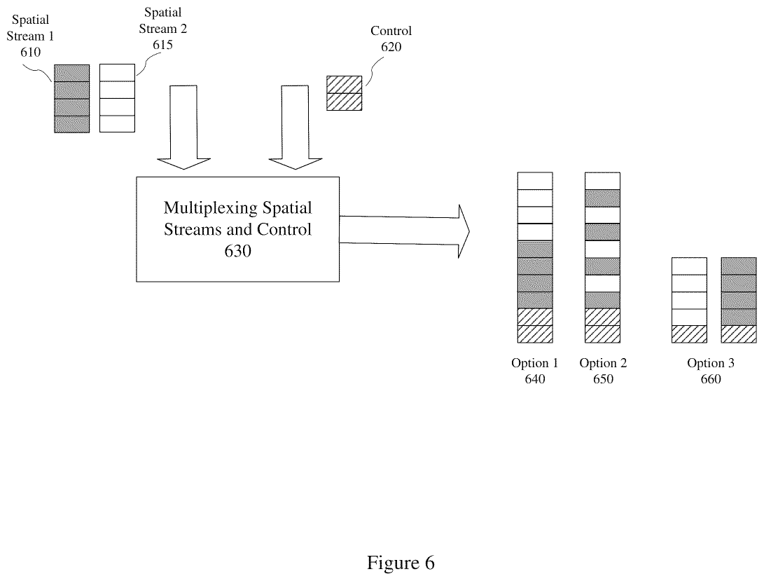

FIG. 6 illustrates three examples of multiplexing functions operable within the multi-stream processing logic 520 in accordance with various embodiments of the invention. As shown, the multiplexing spatial streams and control logic 630 receives a first spatial stream 610, a second spatial stream 615 and control information 620 in this particular example of one or more embodiments. The multiplexing spatial streams and control logic 630 may interleave these inputs using a variety of methods including the three examples described herein.

In a first example, blocks of the first spatial stream 610 and blocks of the second stream 615 are interleaved. In this illustration, the block length is four blocks in length but the block length may vary across different embodiments. Control information 620 is positioned in front of the interleaved spatial stream blocks as shown in option 1 640. In a second example, the first spatial stream 610 and second spatial stream 615 are interleaved on a block-by-block basis (block length is one) with control information 620 positioned in front of the interleaved streams.

In a third example, the multiplexing spatial streams and control logic 630 creates two streams in which each of the spatial streams 610, 615 with corresponding control information 620. The resulting multiplexed signals results in two discrete multiplexed signals in which control information is positioned in front of each of the first spatial stream 610 and second spatial stream 615. One skilled in the art will recognize that variations of these three options may also be within the scope of embodiments of the invention including where all control is positioned along with one stream. This can be useful if that stream has more favorable transmission conditions (e.g., lower attenuation due to it occupying lower part of the wireline segment's spectrum) over the wireline segment.

One skilled in the art will recognize that a variety of different interleaving/multiplexing processes may be employed in different embodiments of the invention, all of which should fall within the scope of the invention.

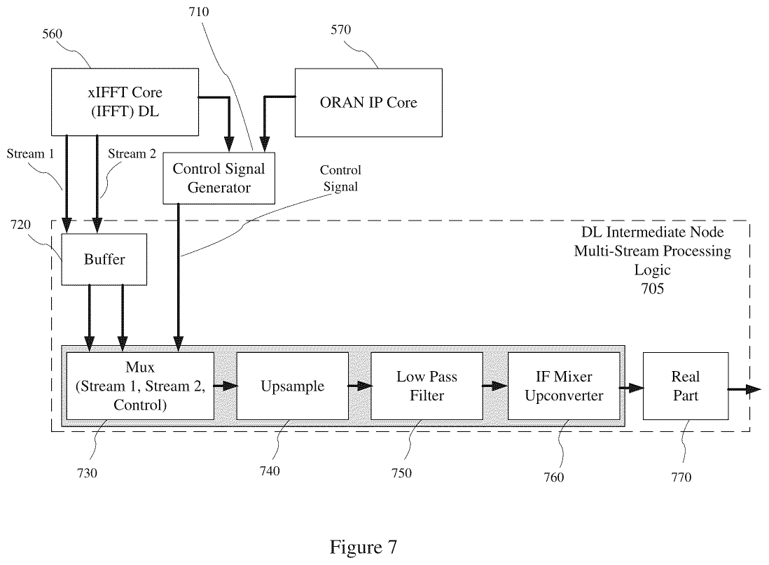

FIG. 7 illustrates exemplary downlink intermediate node multi-stream processing logic 705 in accordance with various embodiments of the invention. In this particular example, the downlink intermediate node multi-stream processing logic comprises a buffer 720 and a single multiplexing path that combines a plurality of spatial streams and control information into a single multi-stream signal.

As shown, the buffer 720 receives a plurality of streams (in this example there are two streams) from the xIFFT core 560 and temporarily stores the streams. A control signal generator 710 receives control information from the xIFFT core 560 and the ORAN IP core 570, and generates a control signal that will be multiplexed with the plurality of streams.

A multiplexer 730 receives the plurality of streams from the buffer 720 and the control signal from the control signal generator 710. The multiplexer 730 combines the plurality of streams and control signal to generate a multi-stream signal. Examples of how the streams and control signals are multiplexed are shown as option 1 640 and option 2 650. However, one skilled in the art will recognize that other multiplexing processes may be used within embodiments of the invention.

The multi-stream signal is transmitted to upsample logic 740, which upsamples the multi-stream signal at a higher rate. The resulting signal is provided to a low-pass filter 750, an IF mixer up-converter 760, and real-part extractor 770 which generates a signal used for transmission on a wireline after a DAC operation such as the DAC 595. The up-converted signal operates at an intermediate frequency that may be communicated on the wireline medium.

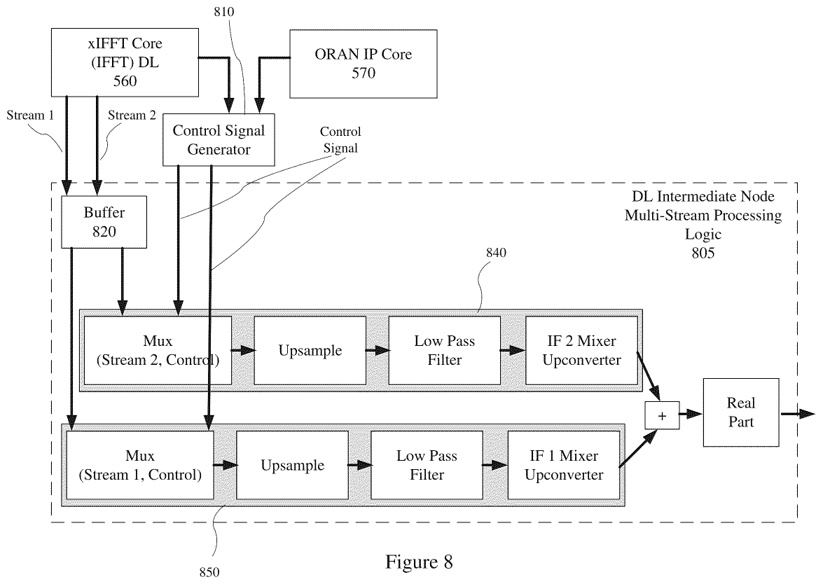

FIG. 8 illustrates another embodiment of the downlink intermediate node multi-stream processing logic in accordance with various embodiments. Comparative to the previous example, the downlink intermediate node multi-stream processing logic 805 comprises a buffer 820 and multiple multiplexing paths that combine a plurality of spatial streams and control information into one or more signals. One example of how a plurality of signals is generated is described as option 3 660.

The buffer 820 receives a plurality of streams (in this example there are two streams) from the xIFFT core 560 and temporarily stores the streams. A control signal generator 810 receives control information from the xIFFT core 560 and the ORAN IP core 570, and generates control signals that will be multiplexed with the plurality of streams.

The buffer 820 provides a first stream to a first multiplexing path 850. The control signal generator 810 provides a first control signal to the first multiplexing path 850. The first multiplexing path 850 operates in a similar manner as discussed in FIG. 7 with the first multiplexing path 850 combining the first stream with at least a part of the control information. The resulting signal is a combination of the first stream and a first control signal.

The buffer 820 provides a second stream to a second multiplexing path 840. The control signal generator 810 provides a second control signal to the second multiplexing path 840. The second multiplexing path 840 operates in a similar manner as discussed in FIG. 7 with the second multiplexing path 840 combining the second stream with control information. The resulting signal is a combination of the second stream and a second control signal.

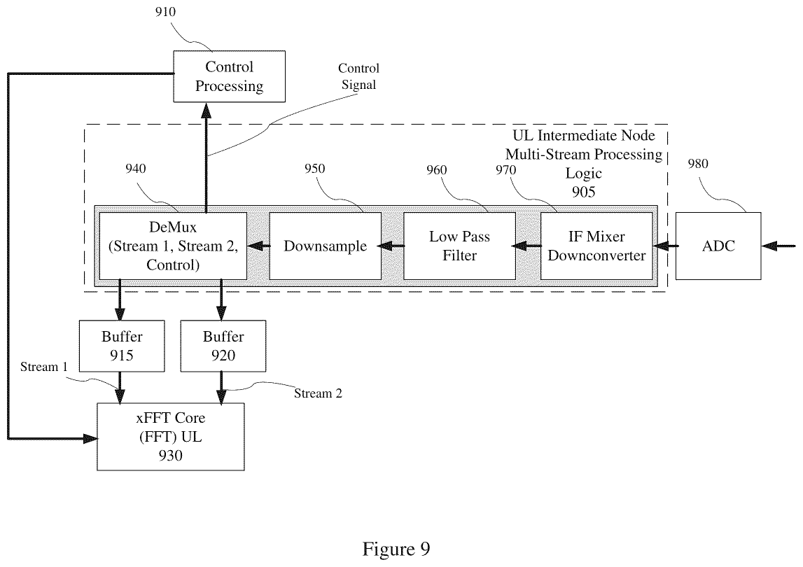

FIG. 9 illustrates exemplary uplink intermediate node multi-stream processing logic according to various embodiments of the invention. The uplink intermediate node multi-stream processing logic 905 comprises a demultiplexer 940, downsample logic 950, a low-pass filter 960 and an IF mixer down-converter 970.

As shown, an uplink multi-stream signal is converted to a digital signal by an analog-to-digital converter 980. Examples of the multi-stream signal may be those corresponding to option 1 640 and option 2 650 in FIG. 6 in which a plurality of streams and control information are interleaved into a single signal.

The converted digital signal is received by the uplink intermediate node multi-stream processing logic 905 at an IF mixer down-converter 970, which down-converts the digital signal. The down-converted signal is filtered by low-pass filter 960 and down sampled by downsample logic 950. The downsampled signal is provided to a demultiplexer 940 which generates a plurality of streams (in this instance two streams) and a control signal.

In this example, the plurality of streams comprises a first stream and a second stream which are provided to corresponding buffers 915, 920. The demultiplexer 940 also extracts the control signal from the multi-stream signal and provides the control signal to control processing logic 910. One skilled in the art will recognize that various number of streams may be combined within a multi-stream signal and extracted by the demultiplexer 940.

The buffers 915, 920 transmit the first and second streams to an xFFT core 930 and the control processing logic 910 transmits control information to the xFFT core 930. The xFFT core 930 converts the first and second streams (and may also convert at least a portion of the control information) to the frequency domain to the time domain, from which a corresponding signal is eventually transmitted to a BBU.

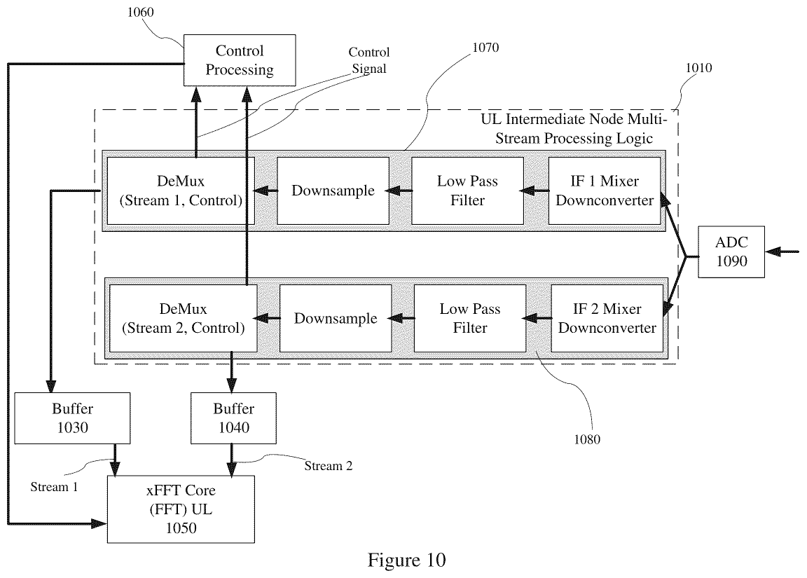

FIG. 10 illustrates another example of an uplink intermediate node multi-stream processing logic according to various embodiments of the invention. As shown, the uplink intermediate node multi-stream processing logic 1010 comprises a plurality of demultiplexing paths (in this case two paths) 1070, 1080. This uplink intermediate node multi-stream processing logic 1010 may demultiplex streams similar to those illustrated in option 3 660 in FIG. 6.

A multi-stream signal is received at an ADC 1090 that converts the signal from the analog domain to the digital domain. Examples of multi-stream signals include those in which control information and a data stream are combined such as those in option 3 660. The signal generated by the ADC is provided to demultiplexing paths 1070, 1080 for demultiplexing data and control.

In this embodiment, a signal is down-converted, filtered by a low-pass filter and downsampled prior to being transmitted to a demultiplexer. The demultiplexer separates data and control. In this example, a first demultiplexer sends a first stream to a first buffer 1030 and a first control signal to control processing logic 1060. A second demultiplexer sends a second stream to a second buffer 1040 and a second control signal to control processing logic 1060.

The control processing logic 1060 sends part of the control information to the xFFT core 1050. The first buffer 1030 sends the first stream to the xFFT core 1050 and the second buffer 1040 sends the second stream to the xFFT core 1050. The xFFT core 1050 converts the first and second streams (and may convert at least a portion of the control information) from the time domain to the frequency domain. The converted first and second streams (and also the at least portion of the control information if applicable) is sent to an ORAN core which generates corresponding signals that are transmitted to the BBU.

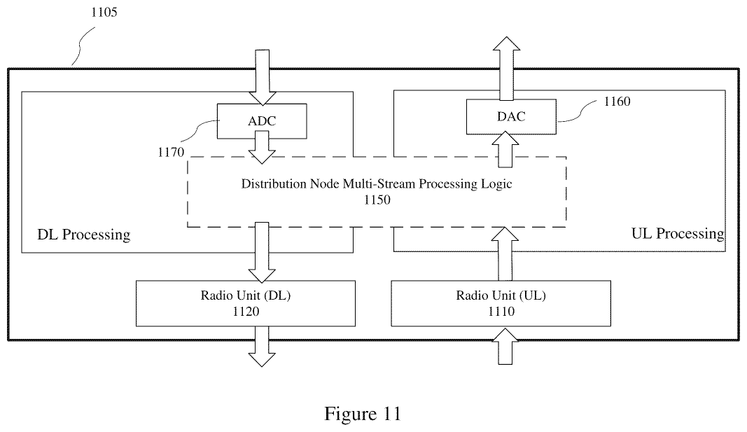

FIG. 11 illustrates an exemplary distribution node according to various embodiments of the invention. The distribution node 1105 interfaces the wireline segment and a wireless segment and comprises a downlink path and an uplink path.

The uplink path comprises an uplink Radio unit 1110 that interfaces the distribution node 1105 with wireless segments within a cell or wireless LAN. Wireless signals are received at the Radio unit 1110 and processed to allow multiplexing of multiple streams within the distribution node 1105. Uplink distribution node multi-stream processing logic 1150 receives a plurality of streams from the Radio unit 1110 and generates a multi-stream signal in a similar manner as described in the downlink intermediate node multi-stream processing logic 705, 805. The resulting multi-stream signal is transmitted to a digital-to-analog converter 1160 and subsequently transmitted on a wireline.

In the downlink, analog-to-digital converter 1170 receives a multi-stream signal from a wireline and converts it to a digital signal. The digital signal is transmitted to downlink distribution node multi-stream processing logic 1150 and demultiplexes the signal into a plurality of streams in a similar manner as described in the uplink intermediate node multi-stream processing logic 905, 1010. The streams are transmitted to a downlink Radio unit 1120 that converts the streams to wireless signals and transmits them wirelessly to intended user equipment and/or remote devices.

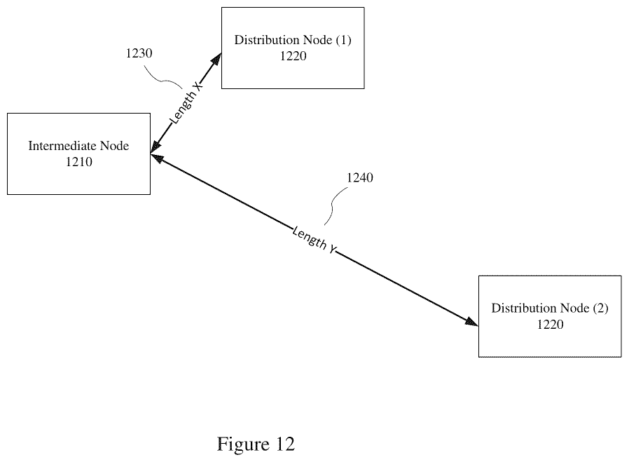

FIG. 12 illustrates an intermediate node coupled to multiple distribution nodes in accordance with various embodiments of the invention. In this particular example, an intermediate node 1210 is coupled to a first distribution node 1220 and a second distribution node 1230. Various embodiments of the invention, described herein, apply to a variety of distribution nodes (and corresponding connections) including the total number of distribution nodes and the type(s) of distribution nodes.

As shown, the distance between distribution nodes and an intermediate node may vary. In this particular example, a first connection 1230 having a length of X provides an uplink channel(s) and a downlink channel(s) between the intermediate node 1210 and the first distribution node 1220. A second connection 1240 having a length Y provides an uplink channel(s) and a downlink channel(s) between the intermediate node 1210 and the second distribution node 1220. In this example, length Y is larger than length X.

The management of wireline components within a wireline-wireless architecture may present issues that are addressed by the use of control information collected, generated and transmitted at various nodes within the architecture. Issues such as wireline segment lengths, the type and quality of a cable within a wireline segment, the use and traffic amount on a wireline segment and other parameters understood by one of skill in the art.

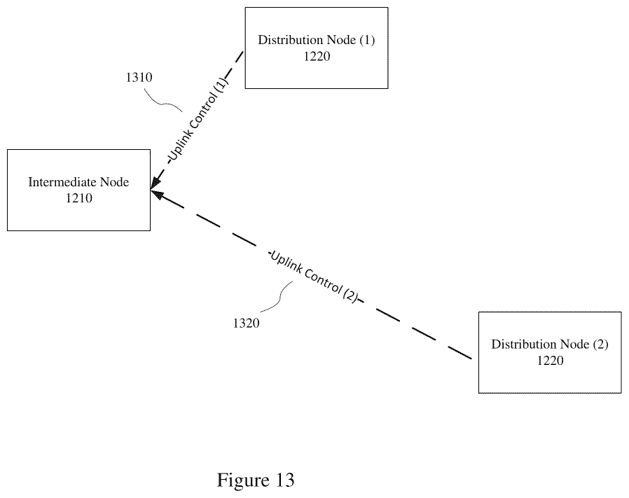

FIG. 13 illustrates an intermediate node receiving uplink traffic from multiple distribution nodes in accordance with various embodiments of the invention. Similar to the previous example, the intermediate node 1210 receives uplink traffic from a first distribution node 1220 on a first wireline connection 1310 and from a second distribution node 1220 on a second wireline connection 1320. As shown, a portion of this uplink traffic may comprise control information measured and/or generated at a distribution node 1220.

The management of this uplink traffic at the intermediate node 1210 may include issues in processing, timing and further transmitting uplink traffic (e.g., control information) within the wireline-wireless architecture. For example, the intermediate node 1210 may aggregate a portion of control information from multiple distribution nodes 1220 across different uplink connections 1230, 1240 having differing transmission characteristics such as rates, bandwidths, etc. In certain embodiments, the intermediate node 1210 functions as an aggregator of uplink traffic, including control information, across multiple wireline connection. Aggregated uplink traffic is combined and transmitted on a single connection to one or more communication device such as an O-DU, base station, Wi-Fi equipment, etc. This aggregation process may be complicated as the number and variance of uplink signals and connections increases.

In certain embodiments, uplink signal aggregation at the intermediate node 1210 employes a weighted sum approach in which a weighted sum value is associated with an entire uplink signal or a portion of the uplink signal. The weight associated with a signal is based on one or more of characteristics of the wireline connection on which it is transmitted, configuration of the intermediate node or control information sent by O-DU. For example, the weighted sum value may be determined based on parameters such as the connection length, the type of cable within the connection, the amount of traffic on the connection and other parameters understood by one of skill in the art.

The weight values may also relate to certain remote wireless devices (e.g., User Equipment, Wi-Fi remote devices, mobile phones, etc.) and specific characteristics of those devices that are communicating within the wireline-wireless network. For example, in a cellular deployment, resource blocks being communicated from a UE may have certain transmission requirements, such as QoS designations, that may be weighted within the weighted sum approach. Resource blocks and corresponding control information having relatively higher QoS designations may receive a higher weight resulting in prioritization during the aggregation process.

One skilled in the art will recognize that a variety of different aggregation processes may be employed using the weighted sum approach. In one example, uplink traffic is prioritized during aggregation based on an assigned weight to either the uplink connection or assigned weight assigned to a particular portion of the uplink traffic on the connection. In various embodiments, the weighted sum approach may be combined with other processes implemented during uplink traffic aggregation.

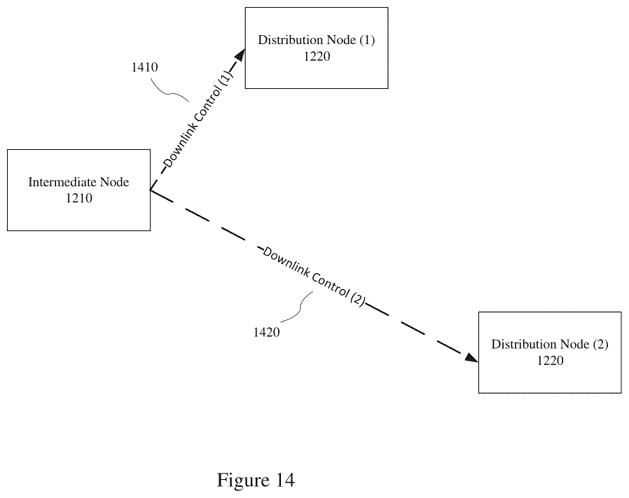

FIG. 14 illustrates an intermediate node transmitting downlink traffic from multiple distribution nodes in accordance with various embodiments of the invention. As shown, an intermediate node 1210 transmits downlink traffic to a first distribution node 1220 on a first downlink connection 1410 and to a second distribution node 1220 on a second downlink connection 1420.

The characteristics of the remote wireless device may also be used in assigning weights that are used to sequence blocks/packets of data and/or control information on a wireline segment. For example, a certain type of wireless device may be prioritized with a higher weight relative to other devices as well as other designations, such as QoS, may be used in defining the sequence of downlink transmissions.

The prioritization of uplink and downlink data and control information may be applied in both time-division duplexed and frequency-division duplexed wireline-wireless architectures.

The management of a wireline-wireless network is based on characteristics of wireless and wireline segments within the network architecture. In various embodiments, intermediate nodes and distribution nodes are able to measure, calculate and transmit control information across a network to facilitate adaptive processes that improve performance based on the segments within the network.

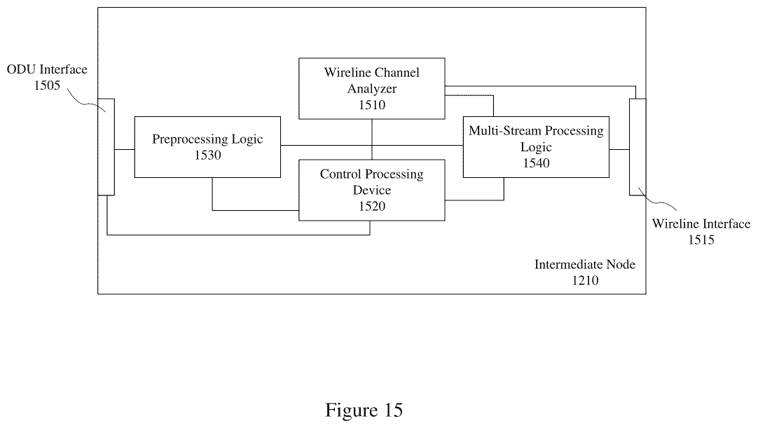

FIG. 15 illustrates an intermediate node in accordance with various embodiments of the invention. The intermediate node 1210 supports the identification and analysis of segment characteristics within the network. In this particular example, the intermediate node 1210 interfaces with cellular equipment but other examples may support other types of wireless networks such as a Wi-Fi network.

The intermediate node 1210 comprises an O-DU interface that is coupled to preprocessing logic 1530 that facilitates communication between the intermediate node 1210 and an O-DU/base station. The preprocessing logic 1530 performs a variety of functions to prepare a received signal for further processing within the intermediate node 1210. For example, the preprocessing logic 1530 may include one or more operations related to reshaping, zero padding, FFT or IFFT. The O-DU interface 1505 may carry out some operations based on ORAN specifications (e.g., O-RAN Fronthaul Working Group Control, User and Synchronization Plane Specification). A control processing device 1520 is coupled to the preprocessing logic 1530, a wireline channel analyzer 1510 and multi-stream processing logic 1540. The multi-stream processing logic 1540 is coupled to a wireline interface 1510, which is coupled to one or more wireline segments.

In certain embodiments, control information from a base station, O-DU, Wi-Fi device or other networked device may be received on the O-DU interface 1505. This control information may be transmitted and/or analyzed at different nodes within the wireline-wireless architecture. Additionally, control information from the O-DU interface 1505 may be supplemented with control information generated and/or analyzed at an intermediate node(s) 1210 and distribution node(s) 1220. The generation and analysis of different control information related to different segments across a wireline-wireless architecture may be used to adjust certain parameters that result in improved performance across the network.

The wireline channel analyzer 1510 receives wireline parameter measurements via the wireline interface 1515, calculates wireline characteristics based at least in part on the wireline parameters measurements and provides wireline information (that may comprise the wireline parameter measurements and/or wireline characteristics) to the control processing device 1520. The control processing device 1520 may additionally receive control information from O-DU (via the O-DU interface 1505) and/or distribution nodes (via Multi Stream Processing Logic 1540). The control processing device 1520 generates control information in part based on one or more of the wireline information, the received control information and configuration of the control processing device 1520. The control processing device 1520 embeds the generated control information in uplink traffic to an O-DU (or other wireless device) and/or downlink traffic to one or more distribution nodes. This control information may also comprise wireless configuration and wireline configuration information. Additionally, control information may be sent or received dynamically or semi-statically.

In certain embodiments, the channel analyzer 1510 receives control information from one or more distribution nodes or reference signals (including pilot tones and other types of signals) that can be analyzed to characterize an uplink channel(s) on a wireline connection. Additionally, the wireline channel analyzer 1510 may receive wireless transmission parameters from one or more distribution nodes in various embodiments of the invention. The control information from distribution nodes may be explicitly sent using control packets, and in such cases the control information in control packet may be determined using operations in Multi Stream Processing Logic 1540 and/or Wireline Channel Analyzer 1510.

The channel analyzer 1510 may receive wireline control information that is multiplexed with one or more of the other signals transmitted from a distribution node. As previously mentioned, this control information may be multiplexed using TDD or FDD processes. The control information may also in part be determined based on processing delay associated with a distribution node as well as propagation delay between a distribution node and the intermediate node. The received control information from a distribution node or O-DU may also include an acknowledgement for a previously sent message, a response for a previously sent message. Additionally, the received control information from a distribution node or O-DU may relate to an indication of an unexpected event (e.g., error) detected by a distribution node or O-DU.

The channel analyzer 1510 may also receive one or more identification numbers associated with a distribution node as well as an identifier within received control information that identifies a particular intermediate node to which control information is intended. The received control information may also include an index of a symbol or slot being transmitted with the control information. Also, the received control information may include capabilities of one or more distribution nodes such as supported MIMO configurations, maximum clock rate, supported operation, etc. Furthermore, reference signals (including pilot tones) and channel parameters (such as signal-to-noise, received power, etc.) may be received from a distribution node to further enhance management of one or more wireline segments. One skilled in the art will recognize that numerous types and amounts of control information may be received by the intermediate node.

The control processing 1520 may also prepare control information to be transmitted to one or more distribution nodes. The control information may be determined in part based on a set of resource blocks of a received uplink signal(s) that are to be transmitted by a distribution node using a wireline connection. The control information may be determined in part based on a set of resource blocks of a received downlink signal(s) that are to be transmitted by a distribution node using its wireless connection. The control information may also be determined in part based on processing delay associated with the intermediate node as well as propagation delay between a distribution node and the intermediate node. This control information may be transmitted by TDD and/or FDD to different distribution nodes with specific transmission periods associated with specific distribution nodes. For example, the transmission period of a specific distribution node may be defined as being related to symbols with a particular index [e.g., mod (symbol_index, 14)=i]. In another example, the transmission period of a specific distribution node may be defined as being only in a slot with a particular index [e.g., mod (slot_index, max_num_node)=I]. The particular index may be determined based on an identification number associated with the specific distribution node. The multiplexing of control information (TDD, FDD, etc.) may be combined with data traffic and/or with one or more spatial streams.

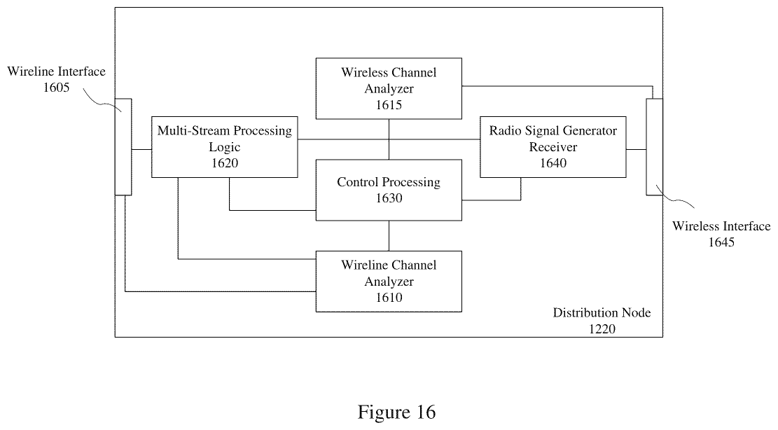

FIG. 16 illustrates a distribution node in accordance with various embodiments of the invention. The distribution node 1220 supports the identification and analysis of segment characteristics within the network. In this particular example, the intermediate node 1220 interfaces with at least one intermediate node and at least one remote wireless device that may be a cellular device, Wi-Fi device or other wireless device known to one of skill in the art.

The distribution node 1220 comprises a wireline interface 1605 that is coupled to multi-stream processing logic 1620 that facilitates communication between the distribution node 1220 and an intermediate node via a wireline segment. A control processing device 1630 is coupled to the multi-stream processing logic 1620, a wireline channel analyzer 1610, a wireless channel analyzer 1615 and a radio signal generator/receiver 1640. The radio signal generator receiver 1640 is coupled to a wireless interface 1645 that wirelessly interfaces one or more wireless devices.

In certain embodiments, the wireline channel analyzer 1610 receives control information from one or more intermediate nodes or reference signals (including pilot tones, reference signals and other types of signals) that can be analyzed to characterize a downlink channel(s) on a wireline connection. Additionally, the wireline channel analyzer 1610 may receive wireless transmission parameters from one or more intermediate nodes in various embodiments of the invention.

The wireline channel analyzer 1610 or Multi Stream Processing Logic 1620 may receive wireline control information that is multiplexed with one or more of the other signals transmitted from an intermediate node and/or another distribution node. As previously mentioned, this control information may be multiplexed using TDD or FDD processes. This control information may be in packetized form or may have a certain well-defined structures. The control information may also in part be determined based on processing delay (e.g., one or more of uplink processing delays, downlink processing delays) associated with an intermediate node as well as propagation delay between an intermediate node and the distribution node 1220. The received control information from an intermediate node may also include an acknowledgement of a previously sent message and/or a response to a previously sent message, etc. Additionally, the received control information from an intermediate node may relate to an indication of an unexpected event (e.g., error) detected by the intermediate node. The received control information from a distribution node may also include an acknowledgement of a previously sent message and/or a response to a previously sent message, etc. Additionally, the received control information from a distribution node may relate to an indication of an unexpected event (e.g., error) detected by the distribution node.

The wireline channel analyzer 1610 or Multi Stream Processing Logic 1620 may also receive one or more identification numbers associated with an intermediate node as well as an identifier within received control information that identifies a particular distribution node to which control information is intended. The sender of the control information may be identified in part using one or more identifiers included in the received control information. The transmitting node and/or desired recipient of control information may be identified in part based on reception period of control information including parameters such as slot index, symbol index or duration associated with the reception period (e.g., only control information received during a reception period associated with symbol index s may be used only by distribution node with identifier I satisfying mod (I,14)=s). The received control information may also include an index of a symbol or slot being transmitted with the control information. Also, the received control information may include capabilities of one or more of intermediate node or a set of distribution nodes such as supported MIMO configurations, maximum clock rate, supported operation, etc. Furthermore, reference signals (including pilot tones) and channel parameters (such as signal-to-noise, received power, etc.) may be received from an intermediate node to further enhance management of one or more wireline segments. One skilled in the art will recognize that numerous types and amounts of control information may be received by the intermediate node.

The control processing unit 1630 may also prepare control information to be transmitted to one or more intermediate nodes. The control information may indicate a set of resource blocks of a received uplink signal(s) to be transmitted by an intermediate node to a base station, O-DU, Wi-Fi equipment or other networking device that is coupled to the intermediate node. The control information may indicate a set of resource blocks of a received downlink signal(s) to be transmitted by an intermediate node to one or more distribution nodes. The control information may also be determined in part based on one or more of a processing delay (e.g., uplink processing delay and/or downlink processing delay) associated with the distribution node, a processing delay associated with the intermediate node, or propagation delay between the distribution node and the intermediate node. This control information may be transmitted by TDD and/or FDD to different one or more intermediate nodes with specific transmission periods. For example, the transmission period of a specific distributed node may be defined as being only related to symbols within a particular index [e.g., mod (symbol_index, 14)=i]. In another example, the transmission period of a specific distributed node may be defined as being only in a slot with a particular index [e.g., mod (slot_index, max_num_node)=I]. More generally, the transmission period (including the start, duration and/or end of the transmission period) of a specific distributed node may be determined based in part on an identifier associated with the distributed node. The particular index may be determined based on an identification number associated with the specific distribution node. The multiplexing of control information (TDD, FDD, etc.) may be combined with data traffic and/or with one or more spatial streams

The wireless channel analyzer 1615 may receive information related to parameters of wireless channels between the distribution node 1220 and one or more remote wireless devices. This received information is obtained using the wireless interface. In certain embodiments, the wireless channel analyzer 1615 may receive control information related to the quality of one or more wireless channels that are coupled to remote wireless devices. This received information may comprise direct measurement of parameters by a remote device in relation to a wireless channel(s) being used by the distribution node 1220, parameters that may be analyzed by the distribution node to enhance understanding of wireless channel performance, signals transmitted from a remove wireless device (e.g., pilot tones, reference signals, etc.) that allow the distribution node 1220 to measure uplink channel parameters, and/or information related to the performance of the wireless remote device such as transmission delay of uplink signals. The wireless channel analyzer 1615 may also receive information related to configuration of wireless interface 1645. The wireless channel analyzer 1615 may provide whole or part of the information it receives to the central processing device 1630.

The control processing device 1630 is coupled to the wireless channel analyzer 1615, wireline channel analyzer 1610 and multi-stream processing logic 1620 to receive information. The control processing device 1630 receives control information sent by an intermediate node using one or more of wireline channel analyzer 1610 and multi-stream processing logic 1620, and this may be realized using control packets and/or reference signals (including pilot tones and other types of signals). The control processing device 1630 uses, processes and/or analyze this information to allow control information to be prepared and/or generated to be transmitted to the multi-stream processing logic 1620 for multiplexing into a wireline signal that is transmitted to an intermediate node 1210 via wireline interface 1605.

The operation of the intermediate node(s) 1210 and the distribution node(s) 1220 may be adapted based on control information that is received and/or generated at a particular node or remote device. The operation includes operation of associated wireline segments and/or wireless segments. As described above, this control information may be transmitted across different segments within the wireline-wireless architecture and may comprise a variety of different types of control information.

In certain embodiments, wireless control information such as transmission parameters related to a distribution node may be generated, analyzed and transmitted to a distribution node including RF transmission and reception frequencies, bands, channels, resource blocks, and other parameters relating to how and when the distribution node transmits and receives wireless signals. Additionally, uplink reception and downlink transmission periods may be communicated to a distribution node or wireless remote device via control information communicated across all or a portion of the wireline-wireless architecture. Other control information, such as transmission power and other parameters known to one of skill in the art may be generated, analyzed and/or transmitted within the wireline-wireless architecture.

In certain embodiments, wireline control information such as transmission parameters related to a distribution node may be generated, analyzed and transmitted including RF transmission and reception frequencies, bands, channels, resource blocks, transmission power, sampling rate, and other parameters relating to how and when the distribution node transmits and receives wireless signals.

The control information may instruct an intermediate node or a distribution node to adjust one or more parameters to improve performance of the wireline-wireless network. This control information may be positioned in front of a data block (such as a preamble), behind the data block (such as a postamble), or as its own block. Additionally, the control information may be multiplexed within a signal using TDD, FDD or other multiplexing processes known to one of skill in the art. Additionally, control information blocks may be adapted to facilitate certain types or amounts of control information being transmitted within the network.

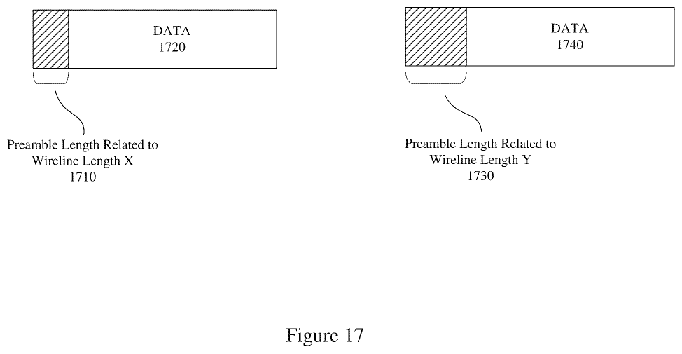

For example, as shown in FIG. 17, a preamble length may be adjusted to facilitate control information that depends on the length of a wireline segment. In a first implementation, a data block 1720 comprises a preamble 1710 that has a size that at least partially relates to a wireline length X. In comparison, a data block 1740 comprises a preamble 1730 having a size that partially relates to a wireline length Y, where length Y is larger than length X. By providing dynamically adaptive processes and structures to transmit control information, the wireline-wireless network may be properly managed while also reducing the amount of bandwidth used to communicate this control information.

As previously discussed, this control information may instruct a node to transmit at a certain power, to transmit signals at certain time periods or frequencies/channels/bands, to encode using a particular method, to supplement a signal with certain features such as error recovery or validation information and/or other parameters known to one of skill in the art. For exemplary purposes, an embodiment in which synchronization between signals is managed using control information.

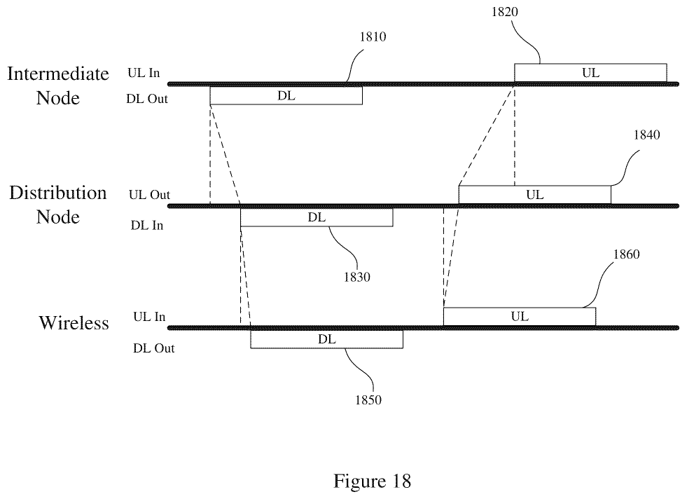

FIG. 18 illustrates timing delay between uplink and downlink transmissions across an intermediate node, a distribution node and a wireless remote device according to various embodiments of the invention. As shown an intermediate node transmits a downlink block 1810 at a first time period and receives an uplink block 1820 at a second time period on a wireline segment. A distribution node receives the downlink block 1830 with a time shift based on transmission time and transmits an uplink block 1840 at a period of time prior to it being received at the intermediate node. Finally, further time shifts are illustrated for a downlink block 1850 and an uplink block 1860 relative to a wireless remote device.

In certain embodiments, a distribution node's RF transmission and reception frequencies/bands/subcarrier-spacing parameters may be determined based on control information that was generated, analyzed and/or transmitted across one or more segments in the wireline-wireless architecture. For example, the distribution node's RF uplink transmission periods may be determined based in part on control and/or synchronization information received from an O-DU, base station, Wi-Fi device, wireless remote device or other devices within the wireline-wireless network. This synchronization information may comprise a variety of different types of parameters such as a set of TDD patterns for wireless segment, frame boundaries, indications in control plane messages associated with a set of symbols that identify the symbols as being uplink or downlink (an example of which is a dataDirection bit in the Application Layer in a C-Plane message, or other control information known to one of skill in the art. In addition, there may be further duration of wireless transmission that are dependent on a symbol index such as symbols associated with certain symbol indices that comprise one or more samples due to a longer cyclic prefix.

Wireline transmission parameters related to intermediate nodes and distribution nodes may be dependent on wireless uplink transmission periods to a distribution node according to various embodiments of the invention. For example, this dependency is illustrated in FIG. 18 as wireline transmissions and/or receptions of intermediate and distribution nodes should be completed before corresponding distribution node wireless transmissions occur. Similarly, wireline transmissions and/or receptions of intermediate and distribution nodes can occur only after corresponding distribution node wireless signals are received. As such, a distribution node may only transmit a subset of resource blocks based on indications from the intermediate node, which in turn is indicated by the O-DU via control plane messaging associated with the wireless uplink reception according to certain embodiments. Further duration of wireless transmission and thus wireline transmissions may be dependent on a symbol index such as symbols associated with certain symbol indices that may comprise one or more samples due to a longer cyclic prefix, for example. One skilled in the art will recognize the advantage of managing and synchronizing transmission and reception of related blocks across wireline and wireless segments to improve timing throughout the network. The generation, analysis and transmission of control information that synchronizes these blocks at intermediate node(s) and distribution nodes(s) provides a variety of processes in which this control information results in an overall improvement of network performance.

It is to be understood that although the disclosures herein are largely in the context of a wireline-wireless converged architecture, the disclosures are not limited to the described environments or applications. Furthermore, although certain 3GPP/cellular terminology and acronyms or initialisms are used herein (e.g., RB, BBU, RAN, MCS, UE, etc.), those having ordinary skill in the art will understand that other terms may be used in other contexts (e.g., Wi-Fi, IEEE 802.11 standards, etc.). For example, in multi-carrier systems (such as those that use orthogonal frequency division multiplexing or discrete multitone modulation), a resource block (which may also be referred to as a resource element) is simply a quantity of time and frequency that can be assigned to a device. It is to be appreciated that resources allocated for communication over a channel can be described in other ways.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

The terms “exemplary” and “embodiment” are used to express examples, not preferences or requirements. The term “coupled” is used herein to express a direct connection/attachment as well as a connection/attachment through one or more intervening elements or structures.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

The foregoing description of the invention has been described for purposes of clarity and understanding. It is not intended to limit the invention to the precise form disclosed. Various modifications may be possible within the scope and equivalence of the appended claims.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. Although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

What is claimed is:

1. An intermediate node comprising:
a first interface coupled to a network device, the first interface receives a first signal to be transmitted through a wireline-wireless network and first control information;
preprocessing logic coupled to receive the first signal and convert the first signal into at least one stream in a time domain;
a wireline channel analyzer coupled to a wireline interface, the wireline channel analyzer performs at least one of receiving second control information from the wireline interface and analyze the second control information; and generates third control information based at least in part on one or more of the first control information and the second control information;
a control processing device coupled to the first interface, the preprocessing logic and the wireline channel analyzer, the control processing generates a fourth control information processing the at least one of the at least one stream, the first control information and the second control information; and
a multi-stream processing logic coupled to receive the at least one stream and the second control information, the multi-stream processing logic multiplexes the at least one stream and the fourth control information for transmission on the wireline interface.

2. The intermediate node of claim 1 wherein the at least one stream and the second control information are multiplexed using time-division multiplexing, frequency division multiplexing or a combination thereof.

3. The intermediate node of claim 1 wherein the control processing modifies the configuration of the intermediate node based on at least one of the at least the one stream, the first control information and the second control information.

4. The intermediate node of claim 3 wherein the modification of configuration the intermediate node comprises at least one of modifying of a wireline transmission power, a wireline transmission bandwidth, a number of spatial streams multiplexed for wireline transmission, a channel used for wireline transmission, a modulation process used for wireline transmission, a period for wireline reception, a period for wireline transmission, a duration for wireline transmission, a periodicity of wireline transmission of control signal, a periodicity of wireline transmission of a preamble, a parameter used in the multi-stream processing logic, a parameter used in the preprocessing logic, an identifier included in wireline transmissions, or a sampling rate used for a wireline transmission.

5. The intermediate node of claim 1 wherein the fourth control information is located in a preamble adjacent to a data block comprising at least a portion of the at least one stream.

6. The intermediate node of claim 5 wherein a length of the preamble is variable.

7. The intermediate node of claim 6 wherein the variable length of the preamble depends at least partially on a wireline length on which the preamble is to be transmitted.

8. The intermediate node of claim 1 wherein the second control information comprises synchronization information that synchronizes periods of transmission or reception of one or more of the one stream across the wireline segment and a corresponding wireless segment.

9. The intermediate node of claim 8 wherein the second control information comprises frame boundaries.

10. The intermediate node of claim 8 wherein the fourth control information comprises at least an indication indicating one or more of an uplink or downlink designation associated with the at least one stream, or a symbol index associated with the first signal.

11. The intermediate node of claim 1 wherein the fourth control information relates to one or more of a transmission power for wireless transmissions, a transmission channel for wireless transmissions, a transmission bandwidth for wireless transmissions, a modulation process for wireless transmissions, a transmission period for wireless transmissions, a reception period for wireless transmissions, an indication of wireless time-division duplexing information, an indication of an unexpected event detected by the intermediate node, a response to previous message received over the wireless interface, a counter for wireless transmission or reception, a counter associated with wireline transmission or reception, an information about a plurality of supported configurations for wireless transmission or reception, an information about a plurality of supported configurations for wireline transmission or reception, or an antenna configuration.

12. The intermediate node of claim 1 wherein the period of transmission of the fourth control information on the wireline interface is determined based in part on one or more of an identifier associated with the desired recipient of the fourth control information, a count of the number of recipients of the transmission of the fourth control information, an identifier associated with the intermediate node, a processing delay of the intermediate node, a processing delay associated with the wireline-wireless network, a propagation delay associated with the wireline segment, a propagation delay associated with the wireless segment, an assessment of priority of contents of the fourth control information, a counter associated with the wireline segment or a counter associated with the wireless segment.

13. The intermediate node of claim 1 wherein the control information is generated in part by multi-stream processing logic.

14. The intermediate node of claim 13 wherein the control information is based at least in part on control packets received from at least one distribution node over the wireline interface.

15. A distribution node comprising:
a wireline interface coupled to a wireline segment within a wireline-wireless network, the wireline interface receives a first signal to be transmitted on a wireless segment within the wireline-wireless network, the first signal comprising first control information;
a multi-stream processing logic coupled to receive the first signal and demultiplexes at least one of the first signal into at least one stream and the first control information;
a wireline channel analyzer coupled to the wireline interface and the multi-stream processing logic, the wireline channel analyzer receives the first control information corresponding to the wireline segment, the wireline channel analyzer generates second control information corresponding to the first control information;
a wireless channel analyzer coupled to a wireless interface, the wireless channel analyzer receives third control information corresponding to a wireless segment within the wireline-wireless network, the wireless channel analyzer generates fourth control information corresponding to the third control information;
a control processing device coupled to the multi-stream processing logic, the wireline channel analyzer and the wireless channel analyzer, the control processing device generates a second signal comprising the at least one stream and at least one of the first, second and fourth control information; and
a radio signal generator receiver coupled to the control processing device, the radio signal generator receiver generates radio signal for transmission using at least the one stream.

16. The distribution node of claim 15 wherein the wireless segment comprises at least one of a cellular connection or a Wi-Fi connection.

17. The distribution node of claim 15 wherein the distribution node determines a period of reception of the first signal based in part on one or more of an identifier associated with the distribution node, an identifier associated with the wireline-wireless network, a processing delay of the distribution node, a processing delay associated with the wireline-wireless network, a propagation delay associated with the wireline segment, a propagation delay associated with the wireless segment, or a counter associated with the wireless segment.

18. The distribution node of claim 15 wherein an operation of the distribution node is modified based on one or more of first, second, third, fourth and fifth control information.

19. The distribution node of claim 15 wherein the modification of the operation comprises at least one of the steps of:
modifying of a transmission power used for wireless transmission or reception,
modifying of a channel used for wireline transmission or reception,
modifying of a channel used for wireless transmission or reception,
modifying of a bandwidth used for wireline transmission or reception,
modifying of a bandwidth used for wireless transmission or reception,
modifying of a subcarrier spacing used for wireless transmission or reception,
modifying of a sampling rate used for wireless or wireline transmission or reception,
modifying of a MIMO configuration used for wireless transmission or reception,
modifying of a TDD configuration used for the wireless transmission or reception,
modifying of a parameter used in the operation of multi-stream processing logic,
modifying of an identifier included in wireline transmissions.

20. The distribution node of claim 15 wherein the at least one of the first, second and fourth control information comprises synchronization information that synchronizes periods of transmission or reception of the at least one stream across the wireless segment and a corresponding wireline segment.

21. The distribution node of claim 15 wherein the at least one of the first, second and fourth control information comprises of one or more of an indicator indicating one or more of an uplink or downlink designation associated with the at least one stream, an identifier associated with the distribution node, an identifier associated a node connected via the wireless interface, or a symbol index associated with the first signal.

22. The distribution node of claim 15 wherein the at least one of the first, second and fourth control information relates to at least one of a transmission power for the wireless segment, a transmission channel for the wireless segment, a transmission bandwidth for the wireless segment, a transmission period for the wireless segment, a reception period for the wireless segment, or a modulation process for the wireless segment.

23. The distribution node of claim 15 wherein the at least one of the first, second and fourth control information relates to one or more of a MIMO configuration, a transmission power, a bandwidth, a subcarrier spacing, a channel, a TDD configuration, on the distribution node.
